(19) United States
(12) Patent Application Publication
(10) Pub. No.: US 2012/0091677 A1
(43) Pub. Date: Apr. 19, 2012

(54) SKATEBOARD

(76) Inventor: Chen-Sung WU, Taichung County (TW)

(21) Appl. No.: 12/904,758

(22) Filed: Oct. 14, 2010

(51) Int. Cl. B62M 1/00; F16D 1/12

(52) U.S. Cl. 280/87.042; 403/26

(57) ABSTRACT

The present invention provides a skateboard including a front board, a rear board, a set of wheels mounted respectively under the front and rear boards, and a swinging connection device connected with the front and rear boards. The swinging connection device includes a front connection board fastened to the front board, a rear connection board fastened to the rear board, a connecting shaft, and a lever, wherein the front and rear connection boards are rotatably connected through the connecting shaft, a surface of the rear connection board facing the front connection board has a position-limiting slot, and the lever has one end fastened to the front connection board and the other end inserted into the position-limiting hole. Furthermore, the swinging connection device adopts a dual-bearing structure, so that through vertically twisting the user's waist and/or legs, it can obtain the motive power for propelling the skateboard.

### FIELD OF THE INVENTION

The present invention is related to sports equipment, and more particularly to a skateboard.

### BACKGROUND OF THE INVENTION

Usually, the skateboard is mainly formed by installing front and rear wheels under a board respectively at two ends thereof During usage, this kind of skateboard should be propelled by pushing one foot on the ground while the other remains on the board, but it is difficult to be propelled with two feet on the board. Then, an improved skateboard is developed to be an upper-arched skateboard with a unidirectional rotational mechanism installed between the rear shaft and rear wheels, so that the motive power produced by vertical vibration of the user on the board can be transformed into the power to propel thee skateboard. However, it needs a great of exertion to achieve a fast speed, which not only disinterests the user, but also might easily hurt the user's ankles and joints owing to excess reaction force.

### SUMMARY OF THE INVENTION

Therefore, for solving the problems in the prior arts, the object of the present invention is to provide a skateboard which can be propelled by twisting the user's waist and/or legs, so as to increase moving speed, save exertion, and also reduce the improper reaction force to the ankles and joints of the user.

For achieving the object of the present invention, the present invention provides a skateboard including a front board, a rear board, a set of wheels mounted respectively under the front board and the rear board, a swinging connection device for connecting the front board and the rear board. The swinging connection device includes a front connection board fastened to the front board, a rear connection board fastened to the rear board, and a connecting shaft and a lever connected between the front connection board and the rear connection board, wherein the front connection board and the rear connection board are rotatably connected through the connecting shaft, a surface of the rear connection board facing the front connection board has a position-limiting slot mounted thereon, and the lever is fastened to the front connection board through one end with the other end inserted into the position-limiting hole.

The present invention is further characterized in that:

A bearing is mounted respectively between the connecting shaft and the front connection board, and between the connecting shaft and the rear connection board, and a front end of the connecting shaft is fastened to the front connection board and the rear connection board through a nut;

The front board and the rear board as well as the front connection board and the rear connection board all have screw holes mounted thereon;

A rolling ball is located between the lever and the position-limiting slot; and

Collision protection covers are further respectively mounted at the ends of the front board and the rear board.

The present invention is constructed of the front board, the rear board, the set of wheels and the swinging connection device. The swinging connection device located between the front board and the rear board adopts a dual-bearing structure, so that through vertically twisting the user's waist and/or legs, the motive power for propelling the skateboard can be obtained, which not only increases moving speed, saves exertion and reduces reaction force to the ankles and joints, but also provides the user more interest.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a perspective view showing the structure of the present invention;

FIG. 2 is a sectional view showing the swinging connection device of the present invention; and

FIG. 3 is an exploded view showing the swinging connection device of the present invention.

### DESCRIPTION OF THE PREFERRED EMBODIMENT

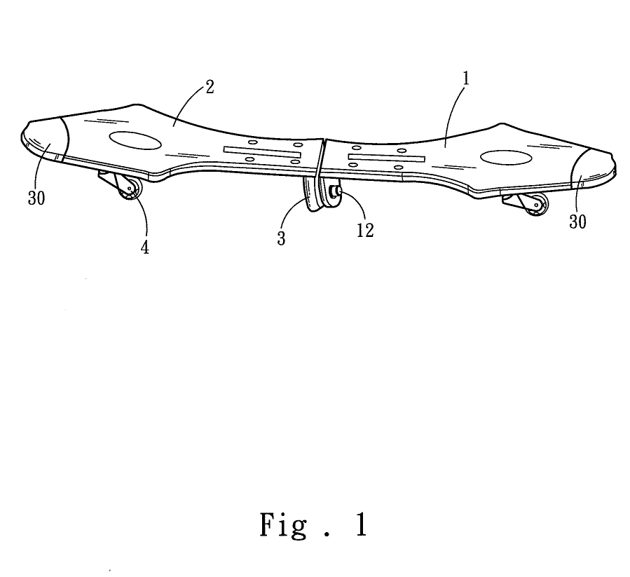

Please refer to FIG. 1. A skateboard includes a front board 1, a rear board 2, a set of wheels 4 mounted respectively under the front board 1 and the rear board 2, and a swinging connection device 3 connected with the front board 1 and the rear board 2, wherein the swinging connection device 3 includes a front connection board 5 fastened to the front board 1, a rear connection board 6 fastened to the rear board 2, a connecting shaft 8, and a lever 20.

The front board 1 and the rear board 2 as well as the front connection board 5 and the rear connection board 6 all have screw holes 7 mounted thereon, so that the front connection board 5 and the rear connection board 6 are respectively fastened to the front board 1 and the rear board 2. Here, the front board 1 and the rear board 2 are fabricated by maple planks, which have advantages of light weight and robust. Besides, collision protection covers 30 are respectively mounted at the ends of the front board 1 and the rear board 2 for preventing damage caused during usage.

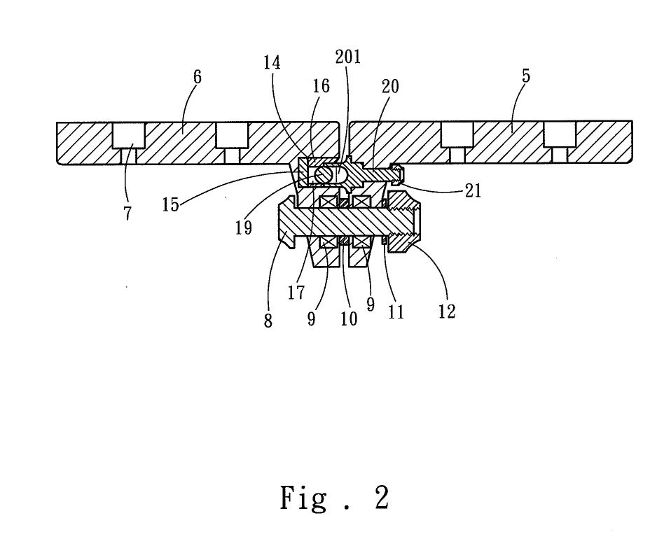

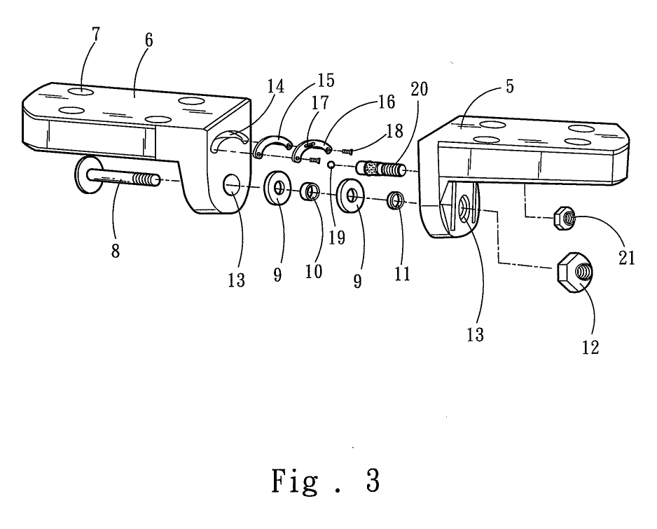

Please further refer to FIG. 2 and FIG. 3 which are respectively a sectional view and an exploded view showing a swinging connection device of the present invention. The front connection board 5 and the rear connection board 6 are rotatably connected through the connecting shaft 8. The surface of the rear connection board 6 facing the front connection board 5 has a position-limiting slot 14 formed thereon, and a stopper 15 and a fixing block 16 are held in the position-limiting slot 14 through a bolt 18. The fixing block 16 has a position-limiting hole 17 formed thereon and a rolling ball 19 is held in the position-limiting hole 17. One end of the lever 20 has a recess 201 and is inserted into the position-limiting hole 17, so as to limit the moving range of the rolling ball 19 between the recess 201 and the stopper 15 in the position-limiting hole 17, and the other end of the lever 20 is fastened to the front connection board 5 through a nut 21. Therefore, through the rolling ball 19 controlling the slide of the limited end of the lever 20 in the position-limiting hole 17, the rear connection board 6 can be controlled to turn right or left, and further, through changing the dimension of the position-limiting hole 17 to adjust the moving range of the lever 20, the turning angle of the rear connection board 6 also can be controlled.

The front connection board 5 and the rear connection board 6 respectively have a screw hole 13 formed on the lower portion thereof for being inserted by the connecting shaft 8 therein, and a bearing 9 is located respectively between the connecting shaft 8 and the front connection board 5, and between the connecting shaft 8 and the rear connection board 6, and with a washer 10 interposed between the two bearings 9. Here, the end of the connecting shaft 8 is fastened to the front connection board 5 and the rear connection board 6 through a nut 12 and a washer 11, so as to achieve a rotational connection of the front connection board 5 and the rear connection board 6.

In the present invention, the swinging connection device 3 located between the front board 1 and the rear board 2 adopts a dual-bearing structure, so that the motive power generated by vertically twisting the user's waist and/or legs can be transformed into the power to propel the skateboard to swing, and the swinging can drive the skateboard toward a desired direction. Therefore, by cooperating the vertical twisting of the user's body with the swinging connection device of the skateboard itself, more motive power can be obtained with less exertion consumption, moving speed can be increased, exertion saved, and the reaction force to the ankles and the joints also can be decreased. In addition, the design further provides the user more interest.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A skateboard, comprising a front board, a rear board, a set of wheels mounted respectively under the front board and the rear board, and a swinging connection device connected with the front board and the rear board, characterized in that:
the swinging connection device comprises a front connection board fastened to the front board, a rear connection board fastened to the rear board, a connecting shaft, and a lever, wherein the front connection board and the rear connection board are rotatably connected through the connecting shaft, a surface of the rear connection board facing the front connection board includes a position-limiting slot, and the lever includes on end fastened to the front connection board and the other end inserted into the position-limiting slot.

2. The skateboard as claimed in claim 1 further comprising bearings located respectively between the connecting shaft and the front connection board, and between the connecting shaft and the rear connection board, and one end of the connecting shaft being fastened to the front connection board and the rear connection board through a nut.

3. The skateboard as claimed in claim 1, wherein the front board and the rear board as well as the front connection board and the rear connection board have screw holes formed thereon.

4. The skateboard as claimed in claim 1 further comprising a rolling ball located between the lever and the position-limiting slot.

5. The skateboard as claimed in claim 1 further comprising collision protection covers respectively mounted at ends of the front board and the rear board.
